(19) United States
(12) Patent Application Publication
(10) Pub. No.: US 2014/0122569 A1
(43) Pub. Date: May 1, 2014

(54) BRIDGING ON PREMISE AND CLOUD SYSTEMS VIA CANONICAL CACHE

(71) Applicant: MICROSOFT CORPORATION, Redmond, WA (US)

(72) Inventors: Todd J. Abel, Redmond, WA (US); Michael Healy, Duvall, WA (US); Zhengkai Kenneth Pan, Redmond, WA (US); David C. James, Snohomish, WA (US); Brett D.A. Flegg, Redmond, WA (US)

(73) Assignee: MICROSOFT CORPORATION, Redmond, WA (US)

(21) Appl. No.: 13/664,001

(22) Filed: Oct. 30, 2012

(51) Int. Cl. G06F 15/16

(52) U.S. Cl. 709/203

(57) ABSTRACT

Sending data using a remote based cache. A method includes receiving at a remote based cache, data from a first system. The data from the first system is intended for a second system. The method further includes caching the data from the first system that is intended for the second system at the cache. The method further includes providing the data from the cache to a third system prior to the data being provided to the second system.

### BACKGROUND

### Background and Relevant Art

Computers and computing systems have affected nearly every aspect of modern living. Computers are generally involved in work, recreation, healthcare, transportation, entertainment, household management, etc.

Further, computing system functionality can be enhanced by a computing systems ability to be interconnected to other computing systems via network connections. Network connections may include, but are not limited to, connections via wired or wireless Ethernet, cellular connections, or even computer to computer connections through serial, parallel, USB, or other connections. The connections allow a computing system to access services at other computing systems and to quickly and efficiently receive application data from other computing system.

Interconnection of computing systems has facilitated distributed or remote based computing systems, such as so-called “cloud” computing systems. In this description, “cloud computing” may be systems or resources for enabling ubiquitous, convenient, on-demand network access to a shared pool of configurable computing resources (e.g., networks, servers, storage, applications, services, etc.) that can be provisioned and released with reduced management effort or service provider interaction. A cloud model can be composed of various characteristics (e.g., on-demand self-service, broad network access, resource pooling, rapid elasticity, measured service, etc.), service models (e.g., Software as a Service (“SaaS”), Platform as a Service (“PaaS”), Infrastructure as a Service (“IaaS”), and deployment models (e.g., private cloud, community cloud, public cloud, hybrid cloud, etc.).

Cloud and remote based service applications are prevalent. Such applications are hosted on public and private remote systems such as clouds and usually offer a set of web based services for communicating back and forth with clients.

Management of client devices is a task performed in distributed computing. Such management may include management directed to managing policies for client devices, such as usage restriction and access requirements. When so called cloud based systems are used, systems may be implemented that have disparate management systems. In particular, in some systems, two disparate management systems are implemented: one cloud based and one on premise. Each management system has a different implementation of core concepts such as grouping, policy, software distribution, etc. Typical integration of the disparate management systems into a single system would be to either construct two different solutions or have the shared function communicate in two different ways.

The subject matter claimed herein is not limited to embodiments that solve any disadvantages or that operate only in environments such as those described above. Rather, this background is only provided to illustrate one exemplary technology area where some embodiments described herein may be practiced.

### BRIEF SUMMARY

One embodiment illustrated herein includes a method that may be practiced in a computing environment. The method includes acts for sending data. The method includes receiving at a remote based cache, data from a first system. The data from the first system is intended for a second system. The method further includes caching the data from the first system that is intended for the second system at the cache. The method further includes providing the data from the cache to a third system prior to the data being provided to the second system.

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

Additional features and advantages will be set forth in the description which follows, and in part will be obvious from the description, or may be learned by the practice of the teachings herein. Features and advantages of the invention may be realized and obtained by means of the instruments and combinations particularly pointed out in the appended claims. Features of the present invention will become more fully apparent from the following description and appended claims, or may be learned by the practice of the invention as set forth hereinafter.

### BRIEF DESCRIPTION OF THE DRAWINGS

In order to describe the manner in which the above-recited and other advantages and features can be obtained, a more particular description of the subject matter briefly described above will be rendered by reference to specific embodiments which are illustrated in the appended drawings. Understanding that these drawings depict only typical embodiments and are not therefore to be considered to be limiting in scope, embodiments will be described and explained with additional specificity and detail through the use of the accompanying drawings in which:

FIG. 1A illustrates a cloud based cache used to store policy information sent from a client management system to a client system;

FIG. 1B illustrates another example of a cloud based cache used to store policy information sent from a client management system to a client system; and

FIG. 1C illustrates a cloud based cache used to store configuration information sent from a client system to a client management system; and

FIG. 2 illustrates a method of sending data.

### DETAILED DESCRIPTION

Some embodiments described herein implement a caching system that allows disparate systems to work together without needing to change the disparate systems themselves to work with each other. Some embodiments provide a canonical caching mechanism shared by different portions of an overall system that allows each different portion to operate independently and without changing code in the different systems. For example, some embodiments use a canonical cache in the cloud (or more generically in a remote based system) to bridge between on premise and cloud based applications. Using this approach, cloud and on-premise applications can both be extended with common functionality and without rewriting either of the applications. Customers can continue to use the application they are familiar with in the way they are used to working. Notably, embodiments may be implemented as extensions to System Center Configuration Manager available from Microsoft® Corporation of Redmond Wash..

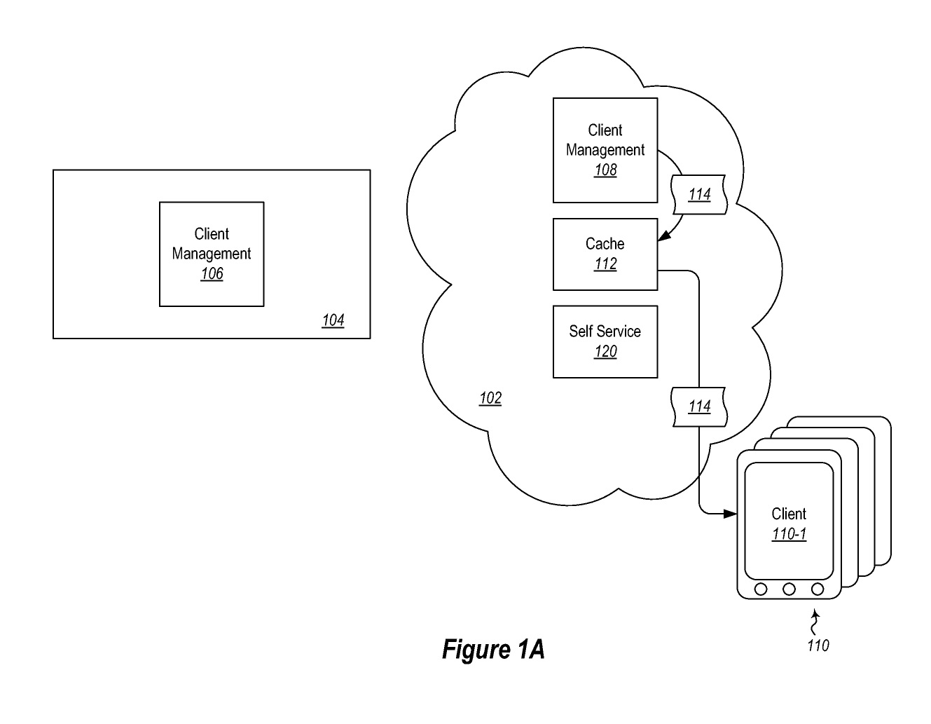

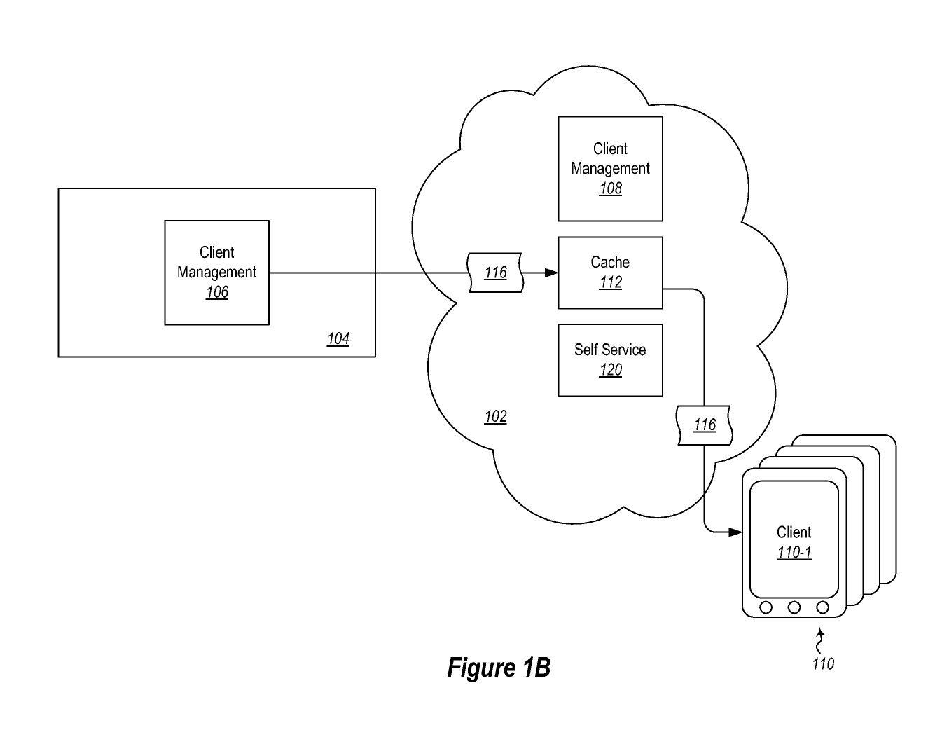

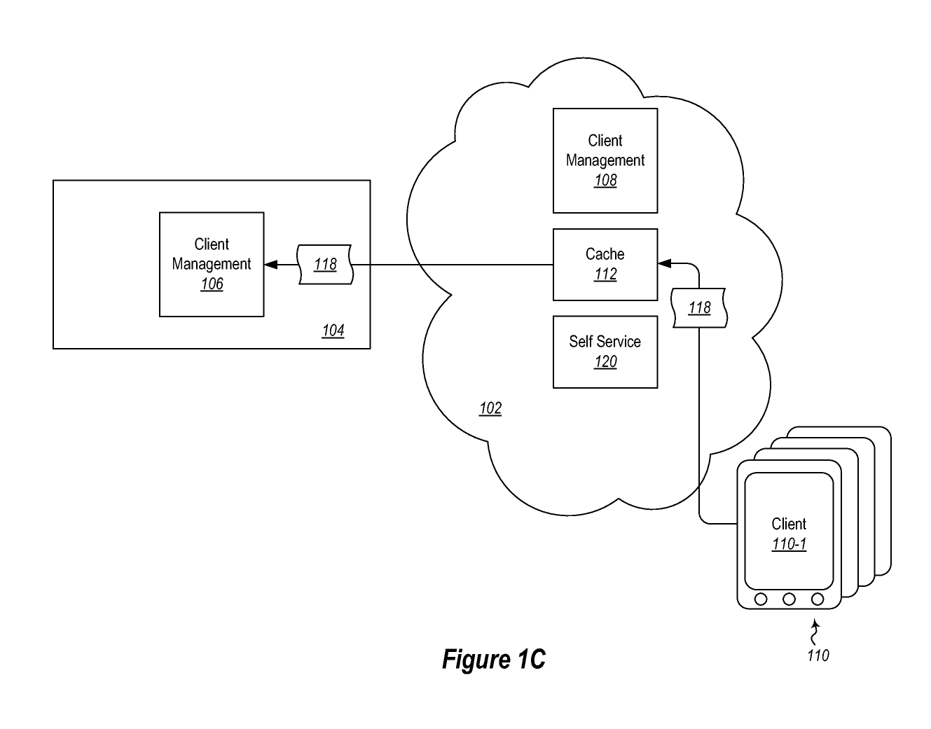

Referring now to FIG. 1A, an example is illustrated. FIG. 1A illustrates a cloud based environment 102 and an on-premises environment 104. An enterprise may utilize services using both local computing systems local to the enterprise at the on-premises environment 104, as well as utilizing service provided remotely, such as in the cloud based environment 102.

In the illustrated example, an enterprise has a client management system 106 deployed at the on premises environment 104, and a separate client management system 108 deployed at the cloud based environment 102. These client management systems 106 and 108 may be used to manage a set of clients 110. For example, the client management systems can enforce policies for the set of clients 110.

FIG. 1A further illustrates a cache 112. When a client management system pushes policy information to a client, the policy information is pushed it through the cache 112. For example, if the client management system 108 wishes to push policy information 114 to the client 110-1 the policy information 114 is first pushed through the cache 112 where it is cached, and then forwarded to the client 110-1. Other client management systems, such as client management system 106, may be able to view the cached policy information 114. In some embodiments, the policy information 114 may be canonically cached such that different client management systems may be able to view the data in spite of the fact that the different systems operate using different communication protocols or have different data format requirements.

Embodiments may be implemented such that the client management system 106 is actually able to view the policy information 114 provided by the client management system 108 to the client 110-1 before the client 110-1 actually receives the policy information 114. This can be done by the client management system 106 consulting the cache 112 prior to the policy information 114 being sent to the client 110-1.

Referring now to FIG. 1B, in a similar fashion, the client management system 106 may push policy information 116 to the client 110-1. Even though the client management system 106 is an on premises system, the policy information 116 is pushed through the cache 112 as it is pushed to the client 110-1. Just as in the previous example, the policy information 116 may be available to other entities (such as the client management system 108) through the cache 112 even before the policy information 116 is provided to the client 110-1.

Referring now to FIG. 1C, other embodiments may be directed to client usage of the cache 112. For example, the client 110-1 may send configuration data 118 to the client management system 106 (or alternatively, client management system 108). The configuration data 118 may include information such as an enumeration of applications installed on the client 110-1, an enumeration of settings at the client 110-1, an indication of what operating system is running at the client 110-1, etc. As illustrated in FIG. 1C, the configuration data is sent from the client 110-2, through the cache 112 and to the client management system 106. The configuration data 118 may be cached at the cache 112. Thus, other management systems (such as management system 108), other clients, or other systems may be able to view the cached configuration data 118.

In some embodiments, the cache 112 may have certain partitions. For example, the cache may be a multitenant cache which is for use by multiple enterprises. Thus, portions of the cache may be “walled-off” on an enterprise basis such that entities can only view portions of the cache for enterprises to which they belong. Alternatively or additionally, the cache may have other restrictions on access. For example, different entities, even with the same enterprise, may have different access rights to data stored at the cache. In other words, entities may be restricted from viewing (or alternatively allowed to view) certain data cached at the cache based on entity permission levels.

FIGS. 1A-1C further illustrate a self service module 120 deployed in the cloud environment 102. The self service module 120 may be a portal allowing a user to directly input information into the cache. For example, the self service module 120 may be a web based portal that allows an admin to place configuration or policy information directly into the cache without needing to go through a client management system or a client.

The following discussion now refers to a number of methods and method acts that may be performed. Although the method acts may be discussed in a certain order or illustrated in a flow chart as occurring in a particular order, no particular ordering is required unless specifically stated, or required because an act is dependent on another act being completed prior to the act being performed.

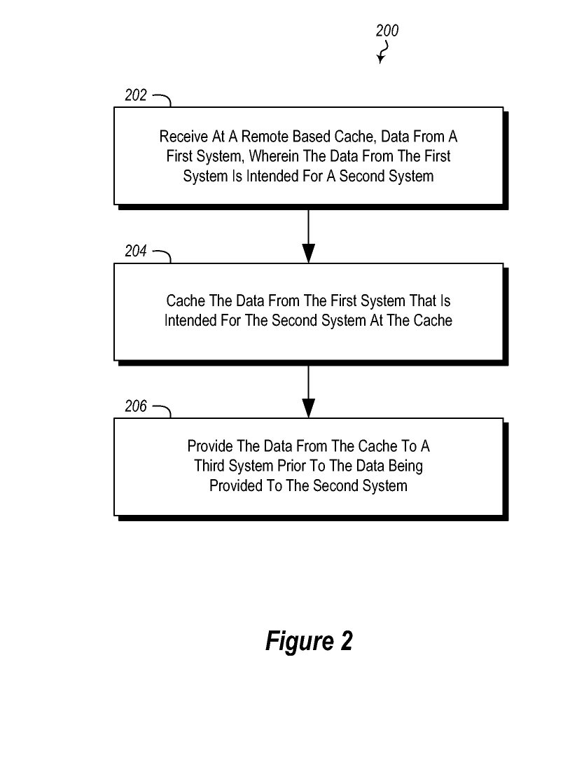

Referring now to FIG. 2, a method 200 is illustrated. The method 200 may be practiced in a computing environment. The method 200 includes acts for sending data. The method includes receiving at a remote based cache, data from a first system (act 202). The data from the first system is intended for a second system. Illustrative examples will be shown below, but may include for example, as illustrated in FIGS. 1A, 1B and 1C, sending policy information 114 from the client management system 108 to the client 110-1, sending policy information 116 from the client management system 106 to the client 110-1, or sending configuration data 118 from the client 110-1 to the client management system 106 (or alternatively client management system 108)

The method 200 further includes caching the data from the first system that is intended for the second system at the cache (act 204). For example, as illustrated in FIGS. 1A-1C information 114, 116 or 118 can be cached in the cache 112. For example, sending data from the first system to the second system may include sending the data through the cache, such that the data can be cached at the cache.

The method 200 further includes providing the data from the cache to a third system prior to the data being provided to the second system (act 206). For example, the policy information 114 is sent from the client management system 108 to the client 110-1 through the cache 112, and cached at the cache 112. The client management system 106 may access the cached policy information 114 at the cache 112 prior to the policy information 114 being provided to the client 110-1. The policy information 114 may be subsequently provided to the client by the client accessing the cache 112 or by the information being sent directly to the client 110-1.

The method 200 may be practiced where caching the data from the first system comprises caching the data in a canonical form. Caching in a canonical form is done such that different data consumers can consume the data in a uniform way including when the different data consumers are not specifically designed to interoperate with each other. A canonical form of data is a form of data that is in a standardized format consumable by many different disparate applications. For example, the second system may have different data communication protocols than the third system yet both the second and third system can access data at the cache because the data is cached in a canonical form.

The method 200 may be practiced where the first system is a client system, the second system is an on-premises based client management system and the third system is a remote based client management system. For example, FIG. 1C illustrates an example of this arrangement. Specifically, the client (i.e. the first system) 110-1 sends configuration information 118 to the on-premises client management system 106 (i.e. the second system) through the cache 112, where the remote based client management system 108 can access the configuration information 118.

The method 200 may be practiced where the first system is a client system, the second system is a remote based client management system and the third system is an on-premises client management system. This embodiment is similar to what is shown in FIG. 1C except that the configuration data 118 is sent to the remote based client management system 108 through the cache 112 rather than the on-premises client management system 106, but where the on-premises client management system 106 can access the configuration data 118 through the cache 112.

The method 200 may be practiced where the first system is a client management system, the second system is client system and the third system is a client system. Example embodiments of this are illustrated in FIGS. 1A and 1B.

The method 200 may be practiced where the data comprises policy information. Examples of this are illustrated in FIGS. 1A and 1B by the policy information 114 and 116.

The method 200 may be practiced where the data comprises configuration information. Examples of this are illustrated in FIG. 1C by the policy information 118.

Further, the methods may be practiced by a computer system including one or more processors and computer readable media such as computer memory. In particular, the computer memory may store computer executable instructions that when executed by one or more processors cause various functions to be performed, such as the acts recited in the embodiments.

Embodiments of the present invention may comprise or utilize a special purpose or general-purpose computer including computer hardware, as discussed in greater detail below. Embodiments within the scope of the present invention also include physical and other computer-readable media for carrying or storing computer-executable instructions and/or data structures. Such computer-readable media can be any available media that can be accessed by a general purpose or special purpose computer system. Computer-readable media that store computer-executable instructions are physical storage media. Computer-readable media that carry computer-executable instructions are transmission media. Thus, by way of example, and not limitation, embodiments of the invention can comprise at least two distinctly different kinds of computer-readable media: physical computer readable storage media and transmission computer readable media.

Physical computer readable storage media includes RAM, ROM, EEPROM, CD-ROM or other optical disk storage (such as CDs, DVDs, etc.), magnetic disk storage or other magnetic storage devices, or any other medium which can be used to store desired program code means in the form of computer-executable instructions or data structures and which can be accessed by a general purpose or special purpose computer.

A “network” is defined as one or more data links that enable the transport of electronic data between computer systems and/or modules and/or other electronic devices. When information is transferred or provided over a network or another communications connection (either hardwired, wireless, or a combination of hardwired or wireless) to a computer, the computer properly views the connection as a transmission medium. Transmissions media can include a network and/or data links which can be used to carry or desired program code means in the form of computer-executable instructions or data structures and which can be accessed by a general purpose or special purpose computer. Combinations of the above are also included within the scope of computer-readable media.

Further, upon reaching various computer system components, program code means in the form of computer-executable instructions or data structures can be transferred automatically from transmission computer readable media to physical computer readable storage media (or vice versa). For example, computer-executable instructions or data structures received over a network or data link can be buffered in RAM within a network interface module (e.g., a “NIC”), and then eventually transferred to computer system RAM and/or to less volatile computer readable physical storage media at a computer system. Thus, computer readable physical storage media can be included in computer system components that also (or even primarily) utilize transmission media.

Computer-executable instructions comprise, for example, instructions and data which cause a general purpose computer, special purpose computer, or special purpose processing device to perform a certain function or group of functions. The computer executable instructions may be, for example, binaries, intermediate format instructions such as assembly language, or even source code. Although the subject matter has been described in language specific to structural features and/or methodological acts, it is to be understood that the subject matter defined in the appended claims is not necessarily limited to the described features or acts described above. Rather, the described features and acts are disclosed as example forms of implementing the claims.

Those skilled in the art will appreciate that the invention may be practiced in network computing environments with many types of computer system configurations, including, personal computers, desktop computers, laptop computers, message processors, hand-held devices, multi-processor systems, microprocessor-based or programmable consumer electronics, network PCs, minicomputers, mainframe computers, mobile telephones, PDAs, pagers, routers, switches, and the like. The invention may also be practiced in distributed system environments where local and remote computer systems, which are linked (either by hardwired data links, wireless data links, or by a combination of hardwired and wireless data links) through a network, both perform tasks. In a distributed system environment, program modules may be located in both local and remote memory storage devices.

Alternatively, or in addition, the functionally described herein can be performed, at least in part, by one or more hardware logic components. For example, and without limitation, illustrative types of hardware logic components that can be used include Field-programmable Gate Arrays (FPGAs), Program-specific Integrated Circuits (ASICs), Program-specific Standard Products (ASSPs), System-on-a-chip systems (SOCs), Complex Programmable Logic Devices (CPLDs), etc.

The present invention may be embodied in other specific forms without departing from its spirit or characteristics. The described embodiments are to be considered in all respects only as illustrative and not restrictive. The scope of the invention is, therefore, indicated by the appended claims rather than by the foregoing description. All changes which come within the meaning and range of equivalency of the claims are to be embraced within their scope.

What is claimed is:

1. In a computing environment, a method of sending data, the method comprising:
receiving at a remote based cache, data from a first system, wherein the data from the first system is intended for a second system;
caching the data from the first system that is intended for the second system at the cache; and
providing the data from the cache to a third system prior to the data being provided to the second system.

2. The method of claim 1, wherein caching the data from the first system comprises caching the data in a canonical form such that different data consumers can consume the data in a uniform way including when the different data consumers are not specifically designed to interoperate with each other.

3. The method of claim 1, wherein the first system is a client system, the second system is a remote based client management system and the third system is an on-premises client management system.

4. The method of claim 1, wherein the first system is a client system, the second system is an on-premise based client management system and the third system is a remote based client management system.

5. The method of claim 1, wherein the first system is a client management system, the second system is client system and the third system is a client system.

6. The method of claim 1, wherein the data comprises policy information.

7. The method of claim 1, wherein the data comprises configuration information.

8. A computing system comprising:
one or more processors; and
one or more computer readable media, wherein the one or more computer readable media comprise computer executable instructions that when executed by at least one of the one or more processors cause at least one of the one or more processors to perform the following:
receiving at a remote based cache, data from a first system, wherein the data from the first system is intended for a second system;
caching the data from the first system that is intended for the second system at the cache; and
providing the data from the cache to a third system prior to the data being provided to the second system.

9. The computing system of claim 8, wherein caching the data from the first system comprises caching the data in a canonical form such that different data consumers can consume the data in a uniform way including when the different data consumers are not specifically designed to interoperate with each other.

10. The computing system of claim 8, wherein the first system is a client system, the second system is a remote based client management system and the third system is an on-premises client management system.

11. The computing system of claim 8, wherein the first system is a client system, the second system is an on-premise based client management system and the third system is a remote based client management system.

12. The computing system of claim 8, wherein the first system is a client management system, the second system is client system and the third system is a client system.

13. The computing system of claim 8, wherein the data comprises policy information.

14. The computing system of claim 8, wherein the data comprises configuration information.

15. A computing system comprising:
a remote based client management system deployed in a remote environment, the client management system configured to provide policy information to clients; and
a remote based cache deployed in the remote environment, the remote based cache configured to receive policy information from the remote based client management system for clients of the remote based client management system and to cache the policy information prior to the policy information being sent to the clients of the remote based client management system, such that a different system is able to access the policy information prior to the clients of the remote based client management system receiving the policy information.

16. The computing system of claim 15, further comprising a self service module configured to allow a user to manually insert policy information into the remote based cache.

17. The computing system of claim 15, wherein the remote based cache is a canonical cache such that data is cached in a canonical form such that different data consumers can consume the data in a uniform way including when the different data consumers are not specifically designed to interoperate with each other.

18. The computing system of claim 15, wherein the remote based cache is further configured to receive configuration from clients of the client management system.

19. The computing system of claim 15, wherein the remote based cache is a multi-enterprise cache, but wherein the remote based cache is walled-off on an enterprise basis such that entities can only view portions of the cache for enterprises to which they belong.

20. The computing system of claim 15, wherein the remote based cache comprises entity based access restrictions.
